(19) United States
(12) Patent Application Publication
(10) Pub. No.: US 2009/0067335 A1
(43) Pub. Date: Mar. 12, 2009

(54) CONGESTION CONTROL IN A TRANSMISSION NODE

(75) Inventors: Ghyslain Pelletier, Boden (SE); Daniel Enstrom, Gammelstad (SE); Stefan Wanstedt, Lulea (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 12/168,078

(22) Filed: Jul. 4, 2008

Related U.S. Application Data
(60) Provisional application No. 60/948,223, filed on Jul. 6, 2007.

(51) Int. Cl. H04L 12/56

(52) U.S. Cl. 370/238

(57) ABSTRACT

Packets are selectively marked or dropped when congestion of the radio resources is experienced, the selective marking/dropping being related to or dependent on the probability that a packet will be marked with the relative efficiency of usage of the radio link by the receiver, e.g., dependent upon radio resource usage costs and fairness. For example, packets are marked or dropped based on a user's associated share of the total (or a subset of the) shared radio resources. This share may be expressed in terms of the costs of the resources in terms the user's level of utilization of the shared resources, or in terms of it's fairness with respect to other users sharing the same resources. Thus, the present technology takes into account the distribution of resources usage between receivers contributing to the congested state of the radio network.

This application claims the benefit and priority of U.S. provisional patent application 60/948,223, filed Jul. 6, 2007, entitled “CONGESTION CONTROL ALGORITHM IN A TRANSMISSION NODE”, which is incorporated by reference herein in its entirety.

### TECHNICAL FIELD

This invention pertains to telecommunications, and particularly to the control of congestion in wireless telecommunications.

### BACKGROUND

It is a well-known fact that packet-switched networks utilizing resources shared between the users can experience congestion. Congestion will happen when the sum of traffic of the ingress nodes of the shared resource exceeds the sum of the traffic of the egress nodes of the same shared resource. The most typical example is a router with a specific number of connections. Even if the router has processing power enough to re-route the traffic according to the estimated link throughput, the current link throughput might restrict the amount of traffic the outgoing links from the router can cope with. Hence, the buffers of the router will build up and eventually overflow. The network then experiences congestion and the router is forced to drop packets.

### Radio Resources And Congestion

Another example of congestion can be found when studying wireless networks with shared channels such as 802.11 a/b/g, High Speed Packet Access (HSPA), Long Term Evolution (LTE), and Worldwide Interoperability for Microwave Access (WiMAX). In these networks, at least the downlink is shared between the users and thus is a possible candidate to experience congestion. In e.g. the case of LTE, the enhanced NodeB (eNB) base station will manage re-transmissions on the Medium Access Control (MAC) layer to the mobile terminal (user equipment, UE) which will have impact on the amount of traffic for which the eNB can provide throughput at any given moment. The more re-transmissions (HARQ and RLC ARQ) required for successful reception at the UE, the less are the available resources (e.g. transmission power, number of available transmission slots) to provide throughput for other users.

In, e.g., the case of LTE, the base station (eNB) will also manage how much redundancy is added to protect the data against transmission errors by selecting a proper Modulation and Coding Scheme (MCS) for the physical channel, and then matches the resulting bits to a number of resource blocks (RB). The more conservative the MCS selected for the transmission (e.g. for UEs in bad radio conditions), the less the available resource blocks to provide throughput for users.

### Congestion And IP Transport Protocols

The normal behavior for any routing node is to provide buffers that can manage a certain amount of variation in input/output link capacity and hence absorb minor congestion occurrences. However, when the congestion is severe enough, the routing node will eventually drop packets.

Transmission Control Protocol (TCP) is a connection-oriented, congestion-controlled and reliable transport protocol. For TCP traffic, a dropped packet will be detected by the sender since no acknowledgment (ACK) is received for that particular packet and a re-transmission will occur. Further, the TCP protocol has a built in rate adaptive feature which will lower the transmission bit-rate when packet losses occur and re-transmissions happen on the Internet Protocol (IP) layer. Hence, TCP is well suited to respond to network congestion.

User Datagram Protocol (UDP) is a connectionless transport protocol that only provides a multiplexing service with an end-to-end checksum. UDP is not reliable or congestion-controlled. UDP traffic thus does not have similar mechanisms as TCP to respond to congestion. UDP traffic is by definition non-reliable in the sense that the delivery is not guaranteed. Missing UDP packets will not be re-transmitted unless the application layer using the transport service provided by UDP has some specialized feature which allows this. UDP by itself does not respond in any way to network congestion, although application layer mechanisms may implement some form of response to congestion.

### Explicit Congestion Notification (ECN)

To further increase the performance of routing nodes, a mechanism called “Explicit Congestion Notification for IP” has been developed. See, e.g., RFC 3168, Proposed Standard, September 2001, incorporated herein by reference. This mechanism uses two bits in the IP header to signal the risk for congestion-related losses. The field has four code points, where two are used to signal ECN capability and the other two are used to signal congestion. The code point for congestion is set in, e.g., routers. When the receiver has encountered a congestion notification it propagates the information to the sender of the stream which then can adapt its transmission bit-rate. For TCP, this is done by using two bits in the TCP header. Prior to their definition for use with ECN, these bits were reserved and not used. When received, these bits trigger the sender to reduce its transmission bit-rate.

The benefit with TCP is dual in this case. As a first benefit, since TCP acknowledges the reception of the incoming packets, all TCP connections automatically have a back-channel (This is not the case with UDP). As a second benefit, TCP has a built-in back-off response to packet losses which also can be used in connection with ECN (This is not available for UDP).

To summarize, ECN with TCP has all the mechanisms available in standards to enable successful deployment. This is also seen in more modern routers and new PC operating systems.

The situation with ECN for UDP is quite different. ECN is defined for IP usage with any transport protocol. However, ECN is only explicitly specified in terms of use with TCP traffic. ECN for UDP needs the same generic mechanisms as ECN for TCP: a fast back-channel and some rate control algorithm.

Within the context of UDP-based real-time communication services such as IMS Multimedia Telephony (MTSI), there is a clear need to manage congestion. Such services are by definition quite sensitive to packet loss. Hence, any means available to avoid such losses should be used. ECN for UDP would be a suitable candidate to alleviate the impact of congestion. It turns out that both requirements for successful ECN usage, fast feedback and rate adaptation, are readily available in many such services, the lacking part is the connection between the ECN bits and the response of the application.

Another aspect of the use of ECN is the congestion avoidance algorithm (described below) used in a congested node to either drop or mark packets to signal congestion.

### Congestion Avoidance Algorithms

Congestion avoidance algorithms include three basic types: Tail Drop, Random Early Detection (RED), and Weighted Random Early Detection (WRED).

A tail drop congestion avoidance algorithm treats all traffic equally and does not differentiate between classes of service. Queues fill during periods of congestion. When the output queue is full and tail drop is in effect, packets are dropped until the congestion is eliminated and the queue is no longer full.

The Random Early Detection (RED) congestion avoidance algorithm addresses network congestion in a responsive rather than reactive manner. Underlying the RED mechanism is the premise that most traffic runs on data transport implementations which are sensitive to loss and will temporarily slow down when some of their traffic is dropped. TCP, which responds appropriately—even robustly—to traffic drop by slowing down its traffic transmission, effectively allows RED's traffic-drop behavior to work as a congestion-avoidance signaling mechanism. A typical RED implementation starts dropping or marking packets when the average queue depth is above a minimum threshold. The rate of dropping or marking packets is increased linearly as the average queue size increases, until the queue size reaches the maximum threshold. At this point, all packets are dropped. Whether a packet is ECN-marked or dropped depends on if the ECN bits shows that the mechanism is enabled. However, when applied to traffic that does not respond to congestion or is not robust against losses, RED induces negative impacts on the service.

A weighted Random Early Detection (WRED) congestion avoidance precedence between IP flows provides for preferential traffic handling of packets with higher priority. WRED can selectively discard or mark lower priority traffic when the average queue depth is above a minimum threshold. Differentiated performance characteristics for different classes of service can be provided in this manner. By randomly dropping or marking packets prior to periods of high congestion, WRED tells the packet source to decrease its transmission rate.

Other variants of similar algorithms exist, where the decisional factor is based on queue sizes, traffic classes, resource reservation, and ECN capabilities. In this respect, network nodes interact with the transport protocols in an attempt to mitigate congestion while providing means to the sender to adapt its sending rate consequently and limit the impact of congestion to applications.

Algorithms to mark or drop packets when congestion is experienced in a network node, henceforth simply referred to as a “marking algorithm”, have so far (i.e. in fixed networks) defined congestion as a function of a node's queue depth. The probability that a packet will be “congestion-marked or dropped” in a queue is derived as a function of the average depth of the queue where it lies. Traffic classes and resource reservation (e.g. RSVP) in this respect are essentially a mean to separate one interface's queue into multiple smaller ones, for the purpose of calculating this probability.

### Congestion In Fixed Packet Data Networks

For fixed packet-switched networks, a link is typically said to be congested when the offered load on the link reaches a value close to the capacity of the link. In other words, congestion is defined as the state in which a network link is close to being completely utilized by the transmission of bytes. This is largely because the capacity of the link is constant over time, and because the physical characteristics of the ingress and of the egress links are similar.

### Congestion In Wireless Networks

Defining congestion in wireless network is more complex than simply relating to capacity in terms of the number of bits that can be transmitted. Congestion in wireless networks can be defined as the state in which the transmission channel is close to being completely utilized.

The total capacity of the transmission channel is distributed between different receivers having different radio conditions. This means that the shared resources are consumed partly by varying levels of redundancy (retransmissions, channel coding) necessary to protect the data that is useful to the user (i.e. IP packets). This tradeoff is conceptually shown in FIG. 1.

### Managing Radio Resources And Cell Capacity

The concept of radio bearers is used in LTE to, e.g., support user data services. End-to-end services (e.g. IP services) are multiplexed on different bearers. These different bearers represent different priority queues over the radio interface.

A bearer is referred to as a GBR bearer if dedicated network resources related to a Guaranteed Bit Rate (GBR) value that is associated with the bearer are permanently allocated (e.g. by an admission control function in the RAN) at bearer establishment/modification. Otherwise, a bearer is referred to as a Non-GBR bearer:
GBR (Guaranteed Bit Rate—UL+DL)
MBR (Maximum Bit Rate—UL+DL)

With respect to how resources are separated between different receivers, there can be a guarantee for some receivers about a specific bit rate, a guaranteed bit rate (GBR). There can also be a part of the cell capacity that is used for data for which no guarantee in terms of bit rate is applicable (non-GBR). Applications, such as real-time applications using codecs that can adapt their bit rate, may fill their allocated GBR and go to a higher rate to fill the non-GBR area, when possible, to increase the application bit rate and hence improve their performance. FIG. 2 shows capacity in terms whether bit rate is guaranteed or not.

### eNode B Measurements

In E-UTRAN, certain types of measurements can be performed internally in the eNode B. These measurements do not need to be specified in the standard; rather they are implementation dependent. The possible measurements serve a number of procedures, such as handovers and other radio resource management.

In particular, the eNode B can perform measurement related to the amount of transmission power in the cell, antenna branch or per resource block (per UE), as well as received power in the UL per cell, per UE, or per resource block.

### Measurements And Handover Decisions

The serving eNode B performs UL measurements on (for instance) the signal-to-interference-ratio (SIR), received resource block power, and the received total wideband power. For a handover (HO) decision, it may also take into account other (downlink) measurements, such as the transmitted (total) carrier power and/or the transmitted carrier power per resource block.

### Problems With Existing Solutions

When the network node that experiences congestion is at one edge of a wireless network, such as a base station transmitter, congestion can occur due to one or more of the following: (1) the ingress data rate is larger than the downlink available throughput for the entire cell; (2) the ingress data rate is larger than the downlink available throughput, for one receiver (UE); (3) a UE is in bad radio conditions; (4) the cell capacity becomes power limited.

In other words, the total bit rate exchanged over the air is distributed between user data and coding rate, where the coding rate is adjusted to the radio conditions the receiver is in.

To make it possible to signal congestion using, e.g., ECN in a manner that is most relevant to quickly efficiently decrease congestion in the radio resources, a mechanism is needed to mark the packets. Packets can (for example) be marked using ECN, even for real-time applications using RTP over UDP.

Using ECN with UDP traffic requires specialized application behavior: upon reception of a congestion notification, the receiver needs to transmit a request to the sender requiring the sender to reduce its bit-rate. When that request arrives at the sender, it should immediately reduce the transmitted bit-rate. The amount of the reduction is determined by the sender, which in turn can base its decision on a number of parameters.

In short, current foreseen mechanisms will not provide efficient marking or packet dropping mechanisms that efficiently address congestion of the radio resources.

### SUMMARY

In accordance with an aspect of the technology described herein, packets are selectively marked or dropped when congestion of the radio resources is experienced, the selective marking/dropping being related to or dependent on the probability that a packet will be marked with the relative efficiency of usage of the radio link by the receiver, e.g., dependent upon radio resource usage costs and fairness. For example, packets are marked or dropped based on a user's associated share of the total (or a subset of the) shared radio resources. This share may be expressed in terms of the costs of the resources in terms the user's level of utilization of the shared resources, or in terms of it's fairness with respect to other users sharing the same resources. Thus, the present technology takes into account the distribution of resources usage between receivers contributing to the congested state of the radio network.

One aspect of the technology concerns a method of operating a communications network. The method comprises detecting congestion of a shared radio resource and, for a user of the shared radio resource, selectively dropping packets allocated to the shared radio resource in accordance with the user's share of the shared radio resources.

In one example embodiment the user's share is expressed in terms of cost or amount of resources associated to a user. In one example implementation, the method further comprises determining the cost, or the amount of resources associated to the user, based on transmitter measurements. For example, the transmitter measurements include at least one of the following: downlink total transmit power; downlink resource block transmit power; downlink total transmit power per antenna branch; downlink resource block transmit power per antenna branch; downlink total resource block usage; uplink total resource block usage; downlink resource block activity; uplink resource block activity; uplink received resource block power; uplink signal to interference ratio (per user equipment unit); uplink UL HARQ block error rate. Another example implementation, comprises determining the cost, or the amount of resources associated to the user, based on at least one of receiver feedback and/or measurements. In an example implementation, the receiver feedback and/or measurements include channel quality indication/(CQI/HARQ) feedback.

An example embodiment further comprises determining the user's share in terms of one or more of the following: the user's fraction of total power; the user's fraction of total interference; the user's fraction of the total number of retransmissions (where in all of the previous a higher ration means a higher cost); channel quality indications; handover measurements; and, the type of modulation and coding scheme used for the user.

An example embodiment further comprises selectively dropping the packets in accordance with the user's share of radio resource usage and relative priority of the user relative to other users in periods of congestion of the shared radio resource.

In another of its aspects, the technology concerns a packet marker which marks or drops packet in accordance with the technique(s) described herein, e.g., selectively dropping packets allocated to the shared radio resource in accordance with the user's share of the shared radio resources.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of tradeoff between “useful bits” and channel coding using the same amount of resource blocks.

FIG. 2 is a diagrammatic view showing operation-controlled partitioning of cell capacity.

FIG. 3 is a diagrammatic view showing layered functional view of functional components of an example LTE eNB node and a user equipment unit (UE).

FIG. 4 is a diagrammatic view showing downlink scheduler input, output and interactions according to an example embodiment.

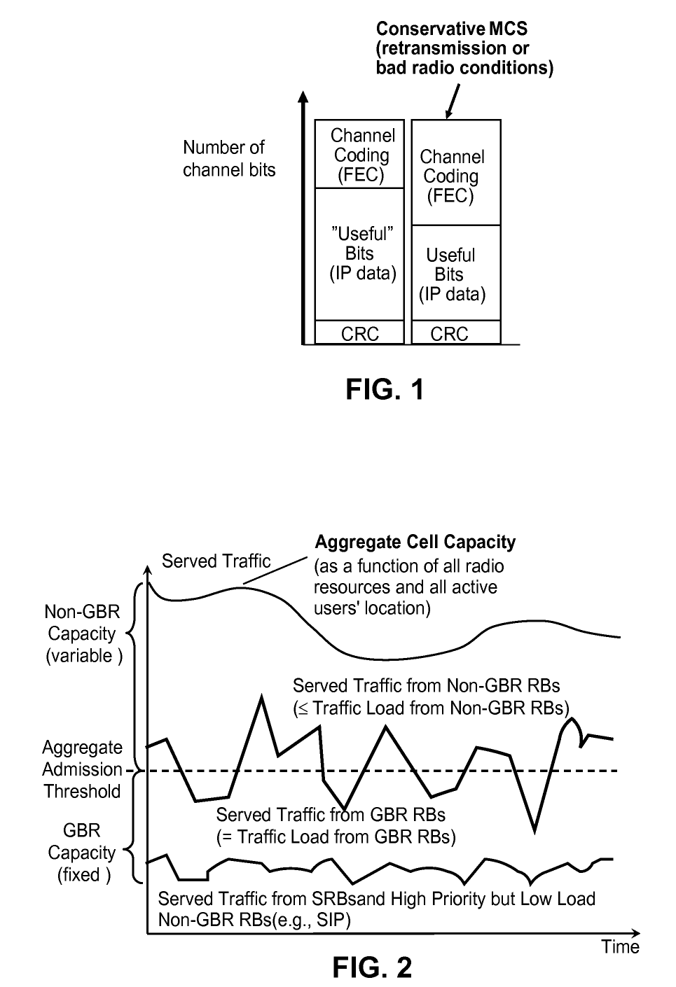

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

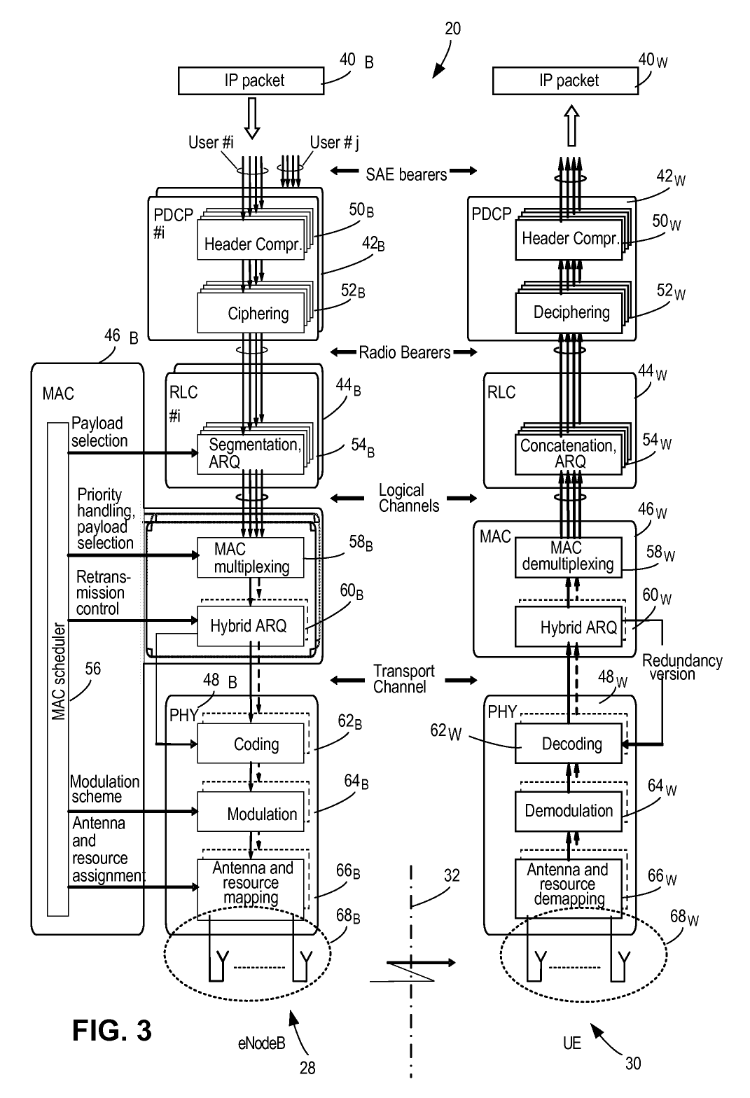

FIG. 3 shows various example functions involved in transmission (eNB) and reception (UE) in a Long Term Evolution (LTE) version of a telecommunications network 20. While LTE is used to exemplify concepts related to radio transmission such as the packet marking technique described herein, similar concepts apply also to other wireless technologies and the technology is thus equally applicable to systems other than LTE.

The telecommunications network 20 includes both base station node 28 (also known as a NodeB, eNodeB, or BNode) and wireless terminal 30 (also known as a user equipment unit [UE], mobile station, or mobile terminal). The wireless terminal 30 can take various forms, including (for example) a mobile terminal such as mobile telephones (“cellular” telephones) and laptops with mobile termination, and thus can be, for example, portable, pocket, hand-held, computer-included, or car-mounted mobile devices which communicate voice and/or data with radio access network. Alternatively, the wireless terminals can be fixed wireless devices, e.g., fixed cellular devices/terminals which are part of a wireless local loop or the like.

Typically base station node 28 communicates over wireless interface 32 (e.g., a radio interface) with plural wireless terminals, only one representative wireless terminal 30 being shown in FIG. 3. Each base station node 28 serves or covers a geographical area known as a cell. That is, a cell is a geographical area where radio coverage is provided by the radio base station equipment at a base station site. Each cell is identified by an identity, which is broadcast in the cell. The base stations communicate over the air interface (e.g., radio frequencies) with the user equipment units (UE) within range of the base stations.

The base station node 28 comprises a radio access network (RAN). If the radio access network is a “flat” type network as occurs in LTE, the base station node 28 essentially performs most of the radio access network functionality and connects to core networks. If, on the other hand, the radio access network is of a more conventional type (such as a Universal Mobile Telecommunications (UMTS) Terrestrial Radio Access Network (UTRAN), one or more base station nodes are connected to the core network through a controller node such as a radio network controller (RNC). The UMTS is a third generation system which in some respects builds upon the radio access technology known as Global System for Mobile communications (GSM) developed in Europe. UTRAN is essentially a radio access network providing wideband code division multiple access (WCDMA) to user equipment units (UEs). The Third Generation Partnership Project (3GPP) has undertaken to evolve further the UTRAN and GSM-based radio access network technologies, the LTE being just one version of evolution.

As those skilled in the art appreciate, in W-CDMA technology a common frequency band allows simultaneous communication between a user equipment unit (UE) and plural base stations. Signals occupying the common frequency band are discriminated at the receiving station through spread spectrum CDMA waveform properties based on the use of a high speed, pseudo-noise (PN) code. These high speed PN codes are used to modulate signals transmitted from the base stations and the user equipment units (UEs). Transmitter stations using different PN codes (or a PN code offset in time) produce signals that can be separately demodulated at a receiving station. The high speed PN modulation also allows the receiving station to advantageously generate a received signal from a single transmitting station by combining several distinct propagation paths of the transmitted signal. In CDMA, therefore, a user equipment unit (UE) need not switch frequency when handoff of a connection is made from one cell to another. As a result, a destination cell can support a connection to a user equipment unit (UE) at the same time the origination cell continues to service the connection. Since the user equipment unit (UE) is always communicating through at least one cell during handover, there is no disruption to the call. Hence, the term “soft handover.” In contrast to hard handover, soft handover is a “make-before-break” switching operation.

FIG. 3 shows an Internet Protocol (IP) packet 40_{B} received at base station node 28, e.g., from a core network or another base station node. FIG. 3 further shows various layer handlers or functionalities comprising base station node 28 and wireless terminal 30. In particular, for base station node 28 and wireless terminal 30, respectively, FIG. 3 shows: PDCP functionality 42_{B} and 42_{W}; radio link control functionality 44_{B} and 44_{W}; medium access control (MAC) functionality 46_{B} and 46_{W}; and physical layer functionality 48_{B} and 48_{W}.

FIG. 3 illustrates that IP packets for plural users are typically in-coming on SAE bearers to base station node 28 from other radio access network nodes or from the core network. “SAE” stands for “System Architecture Evolution”, and an SAE bearer supports a flow and provides Quality of Service (QoS) end-to-end (both over radio and core network). Typically there is a one-to-one mapping between an SAE Bearer and an SAE Radio Bearer. Furthermore there is a one-to-one mapping between a Radio Bearer and a logical channel. It then follows that an SAE Bearer, i.e. the corresponding SAE Radio Bearer and SAE Access Bearer, is the level of granularity for QoS control in an SAE/LTE access system. Packet flows mapped to the same SAE Bearer receive the same treatment. FIG. 3 further illustrates that an instance of each of the aforementioned functionalities can exist for each user (such as user #i depicted as one of the plural users in FIG. 3).

FIG. 3 further illustrates various sub-units of the layer handlers or functionalities for base station node 28 and wireless terminal 30. For example, in base station node 28 PDCP functionality 42_{B} comprises header compressors 50_{B} and ciphering units 52_{B}, and in wireless terminal 30 the PDCP functionality 42_{W} comprises header decompressors 50_{W} and deciphering units 52_{W}. In base station node 28, the radio link control functionality 44_{B} comprises segmentation/automatic repeat request (ARQ) unit 54_{B}, while in wireless terminal 30 the radio link control functionality 44_{W} comprises concatentation/automatic repeat request (ARQ) unit 54. In base station node 28 the medium access control (MAC) functionality 46_{B} comprises MAC scheduler 56; MAC multiplexing units 58_{B}; and Hybrid ARQ units 60_{B}. In wireless terminal 30 the medium access control (MAC) functionality 46_{W} comprises MAC demultiplexing units 58_{W} and Hybrid ARQ units 60_{W}. In base station node 28 the physical layer functionality 48_{B} comprises coding units 62_{B}; modulators 64_{B}; and antenna and resource mapping units 66_{B} which ultimately connect to or comprise transceivers 68_{B}. Conversely, in wireless terminal 30 the physical layer functionality 48_{W} comprises decoding units 62_{W}; demodulators 64_{W}; and antenna and resource mapping units 66_{W} (which connect to or comprise transceiver(s) 68_{W}).

The MAC scheduler 56 is connected to or interacts with various units of functionalities of base station node 28. For example, a payload selection signal is applied from MAC scheduler 56 to segmentation/automatic repeat request (ARQ) unit 54_{B}; priority handling and payload selection signals are applied from MAC scheduler 56 to MAC multiplexing units 58_{B}; retransmission control signals are applied from MAC scheduler 56 to Hybrid ARQ units 60_{B}; modulation scheme signals are applied from MAC scheduler 56 to modulators 64_{B}; and, antenna and resource assignment signals are applied from MAC scheduler 56 to antenna and resource mapping units 66_{B}.

FIG. 3 thus shows how user data in an IP packet 40_{B} is processed by the various layers or functionalities of base station node 28, and is carried to PDCP functionality 42_{B} in a SAE bearer; from PDCP functionality 42_{B} to radio link control functionality 44_{B} by a radio bearer; from radio link control functionality 44_{B} to medium access control (MAC) functionality 46_{B} by a logical channel; and from medium access control (MAC) functionality 46_{B} to physical layer functionality 48_{B} by a transport channel; and is then transported over air interface 32 to wireless terminal 30.

On the side of wireless terminal 30, FIG. 3 also shows how the information received over air interface 32 is handled by physical layer functionality 48_{W}; and then handed over transport channels to medium access control (MAC) functionality 46_{W}, and then handed over logical channels to radio link control functionality 44_{W}; handed over radio bearers to PDCP functionality 42_{W}; and then realized over SAE bearers as a received packet 40_{W}.

In LTE, a shared channel (the DL-SCH) is used for downlink transmissions of user data. As can be seen in FIG. 3, MAC scheduler 56 is the process, functionality, or unit that determines what receiver will be served using the shared resources. The MAC scheduler 56 also determines what resource block (in time and frequency) will be used as well with the proper modulation and coding scheme. User and data rate on the DL-SCH is based on instantaneous channel quality. For the uplink and in other wireless channels where dedicated radio bearers are used, the shared resource in the amount of interface that can be generated for each UE; this is referred to as an interference limited system.

As indicated previously, congestion is typically experienced in a radio network when the shared resources become utilized beyond a certain threshold. For a fixed amount X of radio resources, the amount of user data that is transmitted varies based on radio link conditions.

The present technology marks or drops packets selectively when congestion of the radio resources is experienced. In the illustrated embodiment, the selective marking/dropping of packets during congestion according to the criteria/techniques described herein can be implemented in or realized by in a suitable functionality in a node such as a base station (eNB). The functionality which makes the decision to mark or drop a packet according to the foregoing criteria is termed a “packet marker” and can be, for example, a downlink scheduler (e.g., MAC scheduler 56), or a separate process that monitors the queues of the scheduler, or separate process with its own queues prior to the scheduler.

The selective marking/dropping technique of the present technology is related to or dependent on the probability that a packet will be marked with the relative efficiency of usage of the radio link by the receiver, e.g., dependent upon radio resource usage costs and/or fairness. For example, packets are marked or dropped based on a user's associated share of the total (or a subset of the) shared radio resources. This share may be expressed in terms of the costs of the resources in terms the user's level of utilization of the shared resources, or in terms of it's fairness with respect to other users sharing the same resources. Thus, the packet marker and the techniques of the present technology take into account the distribution of resources usage between receivers contributing to the congested state of the radio network.

As used herein, the term “user” refers to a user of radio resources, and thus may be an IP flow (service) [even a packet itself], a radio bearer, a UE, or a group of UEs. Which of those is marked may be based on relative priority between each other, such as using QoS classes, UE subscription information, or the like.

The technology thus encompasses at least two ways of apportioning a user's share: the first way is based on the cost or amount of resources associated to a user; the second way is based on “fairness”.

A user's share of the total costs can be derived in terms of radio resources. The cost, or the amount of resources associated to the user, may be determined based on different measurements, independently or not, such as transmitter measurements and receiver feedback and/or measurements.

As used herein, “fairness” means that both the share of radio resources and QoS and other guarantees provided by the system are used in the decision to mark or drop. On the other hand, in a system with high congestion where QoS targets cannot be reached for several UEs, the eNB can use each UE's share of the resources and use the QoS agreements relative to each other to decide how to mark/drop packets, until congestion levels come back to normal. Thus, “fairness” encompasses a combination of radio resource usage and QoS agreements (bitrate, delay, loss rate, etc) and/or priorities relative to each other, in periods of congestion of the radio resources.

In particular, measurements similar to those for handover (HO) decision can be used to measure a degree of fairness between UEs with respect to their respective resource utilization in the cell, for the purpose of congestion marking and or dropping at the IP transport level. UE measurements that indicate that the UE is getting closer to the threshold used to decide to make a HO means that the UE is in a non-favorable locations, and that radio conditions are deteriorating. In this case, more radio resources (power, retransmissions, etc) are needed to “reach” this UE. In other words, a strong received signal means that the UE does not require as many DL resources to receive the signal, but a weakly received signal means that the UE requires or wants more DL resources. Congestions (and thereby marking) may also occur somewhere in the cell where is not possible to do a handover, hence other measures for congestion marking can also be implemented.

The decision whether or not a packet is marked (or dropped) can also include whether the radio resources consumed by the user exceed the allocated guaranteed bit rate or not, in the case where congestion is experienced or a certain utilization threshold is reached.

For example, capacity gains (or the effect of marking on overall congestion in the cell) may be bigger if flows targeted at UEs in bad radio conditions are marked first—those are using more resources than others because of their poor radio situation. Fairness can be achieved by targeting traffic in the Non-GBR area for such UEs.

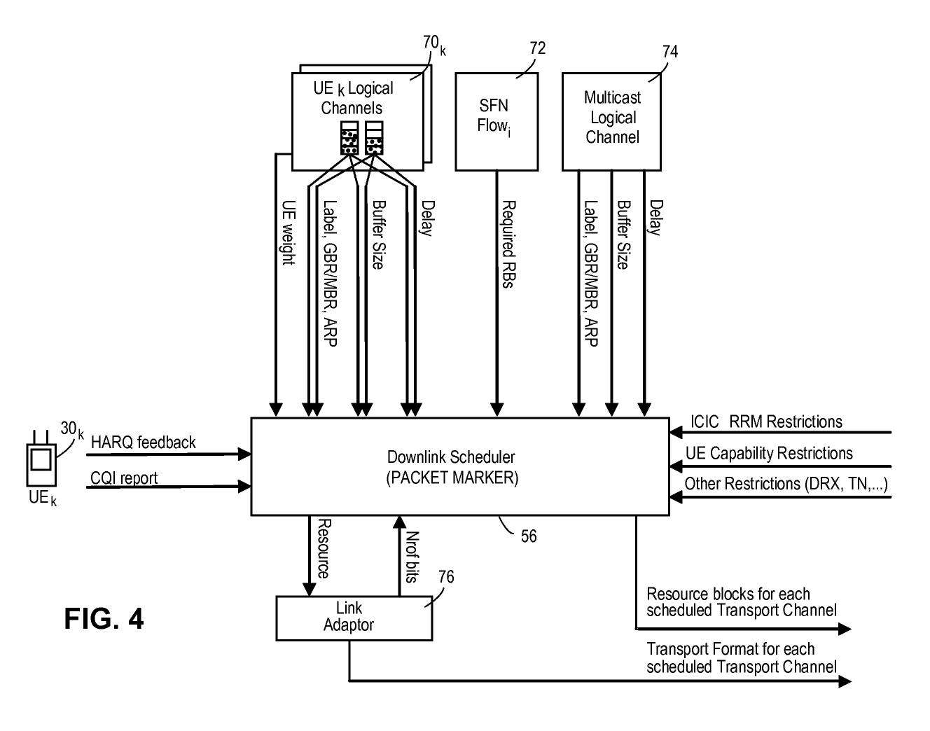

FIG. 4 shows the inputs to a MAC scheduler 56 which, in an example embodiment, performs the role of packet marker and thus performs the decision for packet marking and canceling according to the criteria described herein. In an example embodiment, the packet marker or scheduling function can be implemented by a processor or controller.

FIG. 4 shows that HARQ feedback and CQI reports from representative wireless terminal UEₖ 30 are used as input to the MAC scheduler 56 for reporting the allocation of the shared resources to the receiver. This can be another type of input to the assessment of how much congestion is generated by a UE (relative to others).

The packet marker illustrated as MAC scheduler 56 also receives input regarding the logical channels for the representative wireless terminal 30ₖ, e.g, from the buffer/queue or buffer/queue manager for the logical channels 70ₖ for the representative wireless terminal 30ₖ. For each such channel/queue, the packet marker receives an indication of wireless terminal weight (UE weight); label, GBR/MBR status, and ARP (allocation/retention priority), queue delay, and queue (buffer) size. “Label: is also called QoS class identifier (qci) [see, e.g., 3GPP TS 23.203], and can be a scalar that is used as a reference to a specific packet forwarding behavior (e.g., packet loss rate, packet delay budget) to be provided to a SDF.

The packet marker illustrated as MAC scheduler 56 also receives input from a functionality or unit 72 that monitors the system frame number (SFN) flow and apprises the MAC scheduler 56 of the number of radio bearers required for the representative wireless terminal 30ₖ.

The packet marker illustrated as MAC scheduler 56 can also receive input from a suitable unit 74 regarding a multicast logical channel in the event that the representative wireless terminal 30ₖ participates in a multicast transmission. The information received by the packet marker from unit 74 regarding the multicast transmission basically pertain to the buffer for the multicast transmission and include label; GBR/MBR status; buffer/queue delay; and queue (buffer) size.

The packet marker illustrated as MAC scheduler 56 also receives other restriction information inputs such as those depicted as ICIC/RRM restrictions; UE capability restrictions; and other restrictions (e.g., DRX, TN, . . . ).

The packet marker illustrated as MAC scheduler 56 also receives input from link adaptor 76, particularly a number of bits input. The packet marker illustrated as MAC scheduler 56 outputs to link adaptor 76 a resource indication [which is a request for resources given the inputs from the data queue, e.g., for an uplink scheduling request and for a downlink scheduling assignment. The link adaptor 76 in turn outputs an indication of the transport format for each scheduled transport channel.

The packet marker illustrated as MAC scheduler 56 outputs the number of resource blocks for each scheduled transport channel.

As indicated above, the selective marking/dropping technique of the present technology is related to or dependent the probability that a packet will be marked with the relative efficiency of usage of the radio link by the receiver, e.g., dependent upon radio resource usage costs and/or fairness.

Examples of transmitter measurements that can be used to determine a user's share of the total cost include the following:
DL total Tx power: Transmitted carrier power measured over the entire cell transmission bandwidth.
DL resource block Tx power: Transmitted carrier power measured over a resource block.
DL total Tx power per antenna branch: Transmitted carrier power measured over the entire bandwidth per antenna branch.
DL resource block Tx power per antenna branch: Transmitted carrier power measured over a resource block.
DL total resource block usage: Ratio of downlink resource blocks used to total available downlink resource blocks (or simply the number of downlink resource blocks used).
UL total resource block usage: Ratio of uplink resource blocks used to total available uplink resource blocks (or simply the number of uplink resource blocks used).
DL resource block activity: Ratio of scheduled time of downlink resource block to the measurement period.
UL resource block activity: Ratio of scheduled time of uplink resource block to the measurement period.
UL received resource block power: Total received power including noise measured over one resource block at the eNode B.
UL SIR (per UE): Ratio of the received power of the reference signal transmitted by the UE to the total interference received by the eNode B over the UE occupied bandwidth.
UL HARQ BLER: The block error ratio based on CRC check of each HARQ level transport block.

Examples of receiver feedback and/or measurements that can be used to determine a user's share of the total cost include, e.g. CQI/HARQ feedback as described above. In particular, handover measurements and CQI/HARQ feedback can be used in an example mode.

Examples of calculations would include the user's fraction of total power, the user's fraction of total interference, the user's fraction of the total number of retransmissions (where in all of the previous a higher ration means a higher cost), Channel quality indications (CQI, i.e. the UEs measurements of reception quality), handover measurements (where the logic that determines how close to the threshold for performing a handover the UE is, e.g. how close the UE is to getting out of coverage), the type of Modulation and coding scheme used for the user (where lower modulation and higher amount of redundancy indicates higher cost). All these can be used individually or in combination with each other.

Using LTE as a non-limiting example, measurements that can be used to determine a user's share of the total cost include:
Measurements from the serving eNB: Received total WB power, SIR, transmitted (total) carrier power, Transmitted carrier power per resource block (per UE).
Measurements from the UE, reported to the eNB: Reference symbol receiver power, reference symbol received quality, carrier received signal strength indicator.

Some of the layer handler/functionalities or units involved and/or illustrated in FIG. 3 are elaborated below.

In a first step of the transport-channel processing, a cyclic redundancy check (CRC) is calculated and appended to each transport block by ciphering units 52_{B}. The CRC is used to detect transmission errors in the receiver.

For channel coding as performed by coding units 62_{B}, only Turbo-coding can be applied in case of downlink shared channel (DL-SCH) transmission. Channel coding adds redundancy (similar to Forward Error Correction—FEC) to the bits to be transmitted, to compensate for possible transmission errors. The amount of redundancy added depends on the channel quality as estimated by the eNB.

The task of the downlink physical-layer hybrid-ARQ functionality 60 is to extract the exact set of bits to be transmitted at each transmission/retransmission instant from the blocks of code bits delivered by the channel coder. Thus, it is also implicitly the task of the hybrid-ARQ functionality to match the number of bits at the output of the channel coder to the number of bits to be transmitted. The latter is given by the number of assigned resource blocks and the selected modulation scheme and spatial-multiplexing order. In case of a retransmission, the HARQ functionality will, in the general case, select a different set of code bits to be transmitted (Incremental Redundancy).

The downlink data modulation performed by modulators 64_{B} maps blocks of scrambled bits to corresponding blocks of complex modulation symbols. The set of modulation schemes supported for the LTE downlink includes QPSK, 16QAM, and 64QAM, corresponding to two, four, and six bits per modulation symbol respectively.

As indicated above, the base station node 28 can also receive Channel Quality Indicator (CQI) reports from the UE, which measures the quality of the DL reception based on a reference signal either per resource block or per group of resource blocks. The UE can also measure and report the observed DL HARQ BLER, which is the block error rate based on CRC check of each HARQ level transport block. The eNB also can receive HARQ ACKs and NACKs for every downlink transmission.

Functions that determine QoS in shared channel access networks (not only radio) are the following:
(1) Scheduling (UL+DL)
(2) Traffic Conditioning (UL+DL)
   Admission control for GBR bearers
   Rate policing/shaping for GBR and Non-GBR bearers

Another relevant function that can be implemented in an eNode B is queue management which can be optimized for either real-time or non-real-time traffic.

Advantageously the technology solves a problem of how to mark (or drop) IP packets in a radio transmitter (e.g. eNB) so that the radio receiver that contributes the most to the congestion can be signaled that the radio network is experiencing congestion.

In at least some example embodiments, a mechanism such as ECN (marking) or detection or packet losses (dropping) is assumed to be available and to reach the application. It also assumed that the application in the receiver as the means to propagate back feedback to the IP application in the sender. It can be expected that such mechanisms will get deployed in a foreseeable future.

The technology advantageously handles the logic for marking dropping packets, and is thus a component in a broader solution where congestion can be handled with as little packet losses as possible by enabling the sender of IP packets to adjust its send rate to the radio conditions along the path, as well as to adjust to the usage their IP packets are consuming.

Without this functionality, there is a fair risk that the impact on the quality of the session media, when congestion occurs, is distributed randomly in an unfair manner and to a larger number of receivers, resulting in a more drastic drop in media quality and user experience.

With this functionality, on the other hand, the impact of congestion is redistributed to the receivers most responsible for the congested state, in a manner that is fairer than by randomly marking or dropping packets based on e.g. queue state in the transmitter.

Although the description above contains many specificities, these should not be construed as limiting the scope of the invention but as merely providing illustrations of some of the presently preferred embodiments. Therefore, it will be appreciated that the scope of the present invention fully encompasses other embodiments which may become obvious to those skilled in the art. Reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed hereby. Moreover, it is not necessary for a device or method to address each and every problem sought to be solved or described herein.

What is claimed is:

1. A method of operating a communications network comprising:
detecting congestion of a shared radio resource;
for a user of the shared radio resource, selectively dropping packets allocated to the shared radio resource in accordance with the user's share of the shared radio resources.

2. The method of claim 1, wherein the user's share is expressed in terms of cost or amount of resources associated to a user.

3. The method of claim 2, further comprising determining the cost, or the amount of resources associated to the user, based on transmitter measurements.

4. The method of claim 3, wherein the transmitter measurements include at least one of the following: downlink total transmit power; downlink resource block transmit power; downlink total transmit power per antenna branch; downlink resource block transmit power per antenna branch; downlink total resource block usage; uplink total resource block usage; downlink resource block activity; uplink resource block activity; uplink received resource block power; uplink signal to interference ratio (per user equipment unit); uplink UL HARQ block error rate.

5. The method of claim 2, further comprising determining the cost, or the amount of resources associated to the user, based on at least one of receiver feedback and/or measurements.

6. The method of claim 5, wherein the receiver feedback and/or measurements include channel quality indication/(CQI/HARQ) feedback.

7. The method of claim 1, further comprising determining the user's share in terms of one or more of the following: the user's fraction of total power; the user's fraction of total interference; the user's fraction of the total number of retransmissions (where in all of the previous a higher ration means a higher cost); channel quality indications; handover measurements; and, the type of modulation and coding scheme used for the user.

8. The method of claim 1, further comprising selectively dropping the packets in accordance with the user's share of radio resource usage and relative priority of the user relative to other users in periods of congestion of the shared radio resource.

9. A node of a communications network comprising:
a transceiver configured to transmit a shared radio resource to a user;
a packet marker configured, upon detection of congestion of the shared radio resource, to selectively drop packets allocated to the shared radio resource in accordance with the user's share of the shared radio resources.

10. The node of claim 9, wherein the user's share is expressed in terms of cost or amount of resources associated to a user.

11. The node of claim 10, wherein the packet marker is configured to determine the cost, or the amount of resources associated to the user, based on transmitter measurements.

12. The node of claim 11, wherein the node is configured to use transmitter measurements including at least one of the following: downlink total transmit power; downlink resource block transmit power; downlink total transmit power per antenna branch; downlink resource block transmit power per antenna branch; downlink total resource block usage; uplink total resource block usage; downlink resource block activity; uplink resource block activity; uplink received resource block power; uplink signal to interference ratio (per user equipment unit); uplink UL HARQ block error rate.

13. The node of claim 10, wherein the packet marker is configured to determine the cost, or the amount of resources associated to the user, based on at least one of receiver feedback and/or measurements.

14. The node of claim 13, wherein the receiver feedback and/or measurements include channel quality indication/(CQI/HARQ) feedback.

15. The node of claim 9, wherein the packet marker is configured to determine the user's share in terms of one or more of the following: the user's fraction of total power; the user's fraction of total interference; the user's fraction of the total number of retransmissions (where in all of the previous a higher ration means a higher cost); channel quality indications; handover measurements; and, the type of modulation and coding scheme used for the user.

16. The node of claim 9, wherein the packet marker is configured to selectively drop the packets in accordance with the user's share of radio resource usage and relative priority of the user relative to other users in periods of congestion of the shared radio resource.
